(19) United States
(12) Patent Application Publication
(10) Pub. No.: US 2021/0014560 A1
(43) Pub. Date: Jan. 14, 2021

(54) ELECTRONIC APPARATUS, METHOD OF CONTROLLING THE SAME, SERVER, AND RECORDING MEDIUM

(71) Applicant: SAMSUNG ELECTRONICS CO., LTD., Suwon-si (KR)

(72) Inventors: Jinwuk CHOI, Suwon-si (KR); Kyoungjae PARK, Suwon-si (KR); Byuksun KIM, Suwon-si (KR)

(73) Assignee: SAMSUNG ELECTRONICS CO., LTD., Suwon-si (KR)

(21) Appl. No.: 16/924,689

(22) Filed: Jul. 9, 2020

(30) Foreign Application Priority Data
Jul. 9, 2019 (KR) 10-2019-0082404

(51) Int. Cl. H04N 21/431; G06N 3/08; H04N 21/25

(52) U.S. Cl. CPC H04N 21/4318; H04N 21/4316; H04N 21/251; G06N 3/08

(57) ABSTRACT

Disclosed is an electronic apparatus capable of autonomously recognizing an identifier of a content provider. The electronic apparatus includes: a signal input/output unit; and a processor configured to: process an image to be displayed based on a signal received through the signal input/output unit, recognize an identifier of a content provider, present in an identifier region of the image, based on an identifier mask including the identifier region where presence of the identifier is expected within the image, and perform operation based on information of the content provider corresponding to the recognized identifier.

### CROSS-REFERENCE TO RELATED THE APPLICATION

This application is based on and claims priority under 35 U.S.C. § 119 to Korean Patent Application No. 10-2019-0082404 filed on Jul. 9, 2019 in the Korean Intellectual Property Office, the disclosure of which is incorporated by reference herein in its entirety.

### BACKGROUND

### Field

The disclosure relates to an electronic apparatus, a method of controlling the same, a server and a storage medium, in which an identifier of a content provider is automatically recognized from an image.

### Description of the Related Art

A television (TV) receives an image through an image providing apparatus, for example, a set-top box offered by a content provider. In this case, the TV analyzes the received image while transmitting given infrared (IR) signals (home, guide, channel, etc.) of all the image providing apparatuses of corresponding countries through a smart remote controller or infrared (IR) blasting, and searches for a logo of a specific content provider, thereby recognizing the image providing apparatus.

When the logo of the specific content provider is changed in the received image, the TV cannot recognize the content providing apparatus. Therefore, when it is detected that the logo of the content provider is changed, an engineer needs to go on a business trip in person to collect image data, generate a model with regard to the changed logo and perform an update for maintenance.

Like this, it is conventionally required that the engineer manually finds and marks a logo region in the image data collected according to countries, the logo region is learned as divided into thousands of sheets of images by an iterative sliding window technique, and a recognition accuracy of each logo is enhanced through repetition.

Accordingly, such a conventional method has a problem that trip expenses of the engineer are generated to collect the image data when the logo/user interface (UI) menu changes of the content providers of many countries are detected.

Further, although the TV detects the logo/UI (menu) change of the content provider, a problem arises in that automatic recognition continuously fails for a period of time while the engineer is in collecting, learning and updating for maintenance.

### SUMMARY

According to an embodiment of the disclosure, there is provided an electronic apparatus comprising: a signal input/output unit; and a processor configured to: process an image to be displayed based on a signal received through the signal input/output unit, recognize an identifier of a content provider, present in an identifier region of the image, based on an identifier mask comprising an identifier region where presence of the identifier is expected within the image, and perform operation based on information of the content provider corresponding to the recognized identifier.

The processor is configured to generate a self-learning model by recognizing the identifier of the content provider in a second identifier region of the image, based on a plurality of second identifier masks comprising one or more second identifier regions where presence of the identifier of the content provider is expected within the received image.

The processor is configured to detect whether the identifier of the content provider is changed within the image.

The processor is configured to recognize and detect a user interface (UI) within the image.

The processor is configured to divide the image into a plurality of regions, and recognize and detect the UI from the plurality of divided regions.

The processor is configured to recognize the identifier of the content provider in the detected UI.

The processor is configured to set the identifier region or the second identifier region by referring to identifier positions of a plurality of content providers.

The processor is configured to verify whether the recognized identifier is repetitively recognized a predetermined number of times in one identifier region.

The self-learning model comprises an image positioned in the identifier region or the second identifier region.

The processor is configured to separate the verified identifier and apply self-learning to only the separated verified identifier.

The processor is configured to first compare main learning models for the identifier of the content provider within the received image, and then compare the self-learning models based on no recognition of the identifier.

Self-learning comprises transfer learning that reuses the main learning model to learn the self-learning model.

The transfer learning uses pixel operation in units of M×N to M×N blocks.

The processor is configured to identify whether misrecognition occurs in the self-learning model with respect to the main learning model, and identifies whether misrecognition occurs in the self-learning model by capturing a current image N times, based on no misrecognition in the self-learning model with respect to the main learning model.

The processor is configured to use the self-learning model based on no misrecognition in the captured images, and use the main learning model based on the misrecognition in the captured images.

The processor is configured to provide the generated self-learning model to an external server through the signal input/output unit.

The processor is configured to receive a main learning model or the self-learning model from a server through the signal input/output unit.

According to another embodiment of the disclosure, there is provided a method of controlling an electronic apparatus, comprising: receiving an image; recognizing an identifier of a content provider, present in an identifier region of the image, based on an identifier mask comprising an identifier region where presence of the identifier is expected within the image; and perform operation based on information of the content provider corresponding to the recognized identifier.

According to another embodiment of the disclosure, there is provided a server comprising: a server communicator; a processor configured to: collect a plurality of learning models generated as identifiers of content providers from a plurality of electronic apparatuses through the server communicator, measure similarity of the plurality of collected learning models, and select a learning model having a maximum similarity among the measured leaning models and distribute the selected learning model to electronic apparatuses related to the identifier of the content provider.

According to another embodiment of the disclosure, there is provided a computer-readable recording medium stored with a computer program executable by a computer, comprising: the computer program is configured to: recognize an identifier of a content provider, present in an identifier region of the image, based on an identifier mask comprising an identifier region where presence of the identifier is expected within the image, verify whether the recognized identifier is recognized a predetermined number of times in an identifier region of a plurality of images, and generate the verified identifier as a self-learning model.

### BRIEF DESCRIPTION OF THE DRAWINGS

The above and/or the aspects will become apparent and more readily appreciated from the following description of exemplary embodiments, taken in conjunction with the accompanying drawings, in which:

FIG. 1 illustrates an electronic apparatus according to an embodiment of the disclosure;

FIG. 2 is a block diagram of an electronic apparatus according to a first embodiment of the disclosure;

FIG. 3 is a block diagram of a module for recognizing an identifier of a content provider in an electronic apparatus according to an embodiment of the disclosure;

FIG. 4 is a block diagram of an electronic apparatus according to a second embodiment of the disclosure;

FIG. 5 is a block diagram of a server according to an embodiment of the disclosure;

FIG. 6 is a block diagram of a module for collecting and distributing a learning model in a server according to an embodiment of the disclosure;

FIG. 7 is a flowchart showing a method of recognizing an identifier of a content provider from a received image by the electronic apparatus according to the first embodiment of the disclosure;

FIG. 8 illustrates image data provided by a content provider, received through a signal input/output unit of an electronic apparatus;

FIG. 9 illustrates an electronic program guide (EPU) user interface (UI) recognized from the image data of FIG. 8;

FIG. 10 illustrates an identifier mask according to an embodiment of the disclosure;

FIG. 11 illustrates a main learning model and a self-learning model generated based on an identifier of a verified content provider;

FIG. 12 is a flowchart showing a method of automatically recognizing an identifier of a content provider from a received image by an electronic apparatus according to an embodiment of the disclosure;

FIG. 13 illustrates change in the identifier of the content provider from the image data of FIG. 8;

FIG. 14 illustrates an EPG UI recognized from the image data of FIG. 13;

FIG. 15 illustrates an example of dividing image data in which content and a UI are not clearly distinguished;

FIG. 16 illustrates another example of dividing image data in which content and a UI are not clearly distinguished;

FIG. 17 illustrates a second identifier mask;

FIG. 18 illustrates a third identifier mask;

FIG. 19 illustrates a fourth identifier mask;

FIG. 20 illustrates image data for verification of images extracted from an identifier region;

FIG. 21 is a flowchart showing operations of a server according to an embodiment of the disclosure; and

FIG. 22 is a schematic view of collection and distribution in a self-learning module according to an embodiment of the disclosure.

### DETAILED DESCRIPTION OF EXEMPLARY EMBODIMENTS

Below, embodiments of the disclosure will be described in detail with reference to the accompanying drawings. In the drawings, like numerals or symbols refer to like elements having substantially the same function, and the size of each element may be exaggerated for clarity and convenience of description. However, the technical concept of the disclosure and its key configurations and functions are not limited to those described in the following embodiments. In the following descriptions, details about publicly known technologies or configurations may be omitted if they unnecessarily obscure the gist of the disclosure.

In the disclosure, terms “have,” “may have,” “include,” “may include,” etc. indicate the presence of corresponding features (e.g. a numeral value, a function, an operation, or an element such as a part, etc.), and do not exclude the presence of additional features.

In the disclosure, terms “A or B”, “at least one of A or/and B”, “one or more of A or/and B” or the like may include all possible combinations of elements enumerated together. For example, “A or B”, “at least one of A and B”, or “at least one of A or B” may refer to all of the cases of (1) including at least one A, (2) including at least one B, or (3) including all of at least one A and at least one B.

In the disclosure, terms “first”, “second”, etc. are used only to distinguish one element from another, and singular forms are intended to include plural forms unless otherwise mentioned contextually.

In addition, in the disclosure, terms “upper”, “lower”, “left”, “right”, “inside”, “outside”, “inner”, “outer”, “front”, “rear”, etc. are defined with respect to the accompanying drawings, and do not restrict the shape or position of the elements.

Further, in the disclosure, the expression of “configured to (or set to)” may for example be replaced with “suitable for,” “having the capacity to,” “designed to,” “adapted to,” “made to,” or “capable of” according to circumstances. Also, the expression of “configured to (or set to)” may not necessarily refer to only “specifically designed to” in terms of hardware. Instead, the “device configured to” may refer to “capable of” along with other devices or parts in a certain circumstance. For example, the phrase of “the sub processor configured to perform A, B, and C” may refer to a dedicated processor (e.g. an embedded processor) for performing the corresponding operations, or a generic-purpose processor (e.g. a central processing unit (CPU) or an application processor) for performing the corresponding operations by executing one or more software programs stored in a memory device.

An aspect of the disclosure is to solve the foregoing problems and provides an electronic apparatus, a method of controlling the same, a server and a recording medium stored with a computer program, in which an identifier of a content provider is autonomously and rapidly recognized from an image even through the identifier of the content provider is changed.

In the disclosure, an electronic apparatus 10 according to various embodiments may include an electronic apparatus receiving various kinds of content, for example, at least one of a smartphone, a tablet personal computer (PC), a mobile phone, an image phone, an electronic (E)-book reader, a desktop PC, a laptop PC, a netbook computer, a workstation, a server, a personal digital assistant (PDA), an MP3 player, a medical device, a camera, or an wearable device. In some embodiments, the electronic apparatus 10 may for example include at least one of a television (TV), a digital versatile disk (DVD) player, an audio system, a refrigerator, an air conditioner, an oven, a microwave oven, a washing machine, an air cleaner, a set-top box, a home-automation control panel, a security control panel, a media box, a game console, an electronic dictionary, a camcorder, or an electronic frame.

In an alternative embodiment, the electronic apparatus 10 may include at least one of various medial apparatuses (e.g. various portable medical measurement apparatuses (glucose monitors, heart-rate monitors, blood-pressure gauge monitors, thermometers, etc.), magnetic resonance angiography (MRA), magnetic resonance imaging (MRI), computed tomography (CT), scanning machines, ultrasonography machines, etc.), a navigation system, a global navigation satellite system (GNSS), an event data recorder (EDR), a flight data recorder (FDR), a vehicle infotainment system, marine electronic equipment (e.g. a marine navigation system, a gyrocompass, etc.), avionics, security devices, vehicle head units, industrial or household robots, a drone, an automated teller machine (ATM) of a financial institution, a point-of-sales (POS) device of a store, or Internet of Things (IOT) (e.g. a lamp, various sensors, a sprinkler, a fire alarm, a temperature controller, a street light, a toaster, an exerciser, a hot-water tank, a heater, a boiler, etc.).

In the disclosure, a term “user” may refer to a human who uses the electronic apparatus 10 or an apparatus (e.g. an artificial intelligence (AI) electronic apparatus) that uses the electronic apparatus 10.

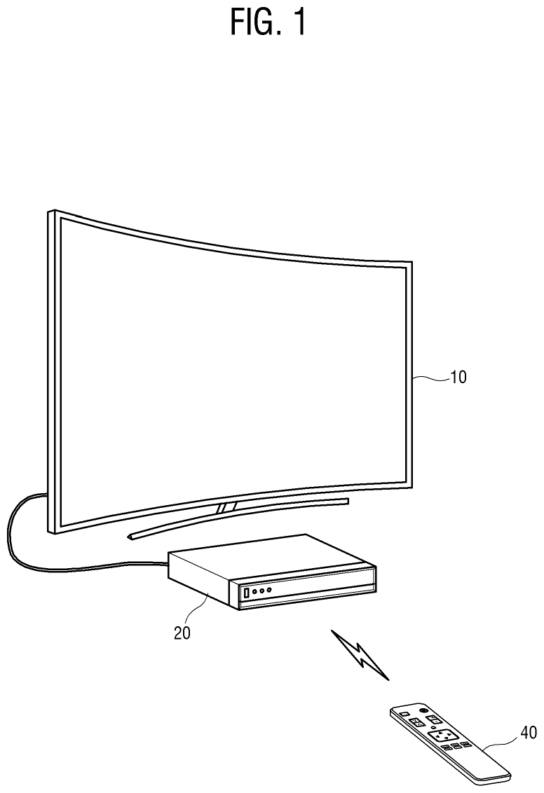

FIG. 1 illustrates the electronic apparatus 10 according to a first embodiment of the disclosure. The electronic apparatus 10 may receive content from a specific content provider. For example, the electronic apparatus 10 may be embodied by a TV that receives streaming image content from a content providing apparatus 20 such as a set-top box or from a server through a network, and is controlled by a remote control signal received from a remote controller 40. Of course, the electronic apparatus 10 is not limited only to the TV, but may be embodied by various electronic apparatuses using various kinds of content provided by the content providers. Further, the electronic apparatus 10 may output an image to an external output apparatus, for example, a monitor, a TV, etc. through an image interface, for example, a high definition multimedia interface (HDMI), a DisplayPort (DP), a thunderbolt, etc. instead of including a built-in display for displaying an image.

As shown in FIG. 1, the electronic apparatus 10 may receive image data including image content and/or an electronic program guide (EPG) user interface (UI).

The electronic apparatus 10 generates an identifier of an content provider by extracting and verifying an image from an identifier region, which is expected to have the identifier of the content provider, in the received image data, for example, in the EPG UI, and uses the generated identifier in recognizing the content providing apparatus 20. A learning model for recognizing the content providing apparatus 20 may mean data or a database (DB) that refers to at least one identifier of the content provider included in the image data, for example, an image and/or a text of a logo and/or a UI given in the form of, for example, a guide or a home menu; a position and/or a size of an identifier region; etc. The learning model may include a main learning model and a self-learning model.

The main learning model may include an identifier of at least one content provider set by an engineer or a user.

The self-learning model is different in characteristics from the main learning model, and may include an identifier of at least one content provider that the electronic apparatus 10 extracts, verifies and learns by itself.

The electronic apparatus 10 detects whether or not the identifier of the content provider is recognized in a previous position; recognizes and detects content, for example, an EPG UI from received image data when the identifier is not recognized; and extracts, verifies and learns images from a plurality of second identifier regions, which are different from each other and expected to have the identifier of the content provider, in the detected EPG UI to thereby generate the self-learning model. Here, the self-learning model may refer to sub-reference data, which is about an image and text within the second identifier region, the position and/or size of the second identifier region, etc., of the image data, as at least one identifier of the content provider different from the main learning model.

Below, recognition of the identifier of the content provider means substantially the same as recognition of the content providing apparatus 20 provided by the content provider, and therefore they will be collectively called the recognition of the identifier of the content provider.

The content providing apparatus 20 may transmit the image content and/or EPG UI provided by the content provider to the electronic apparatus 10 in response to a request. The content providing apparatus 20 may include a set-top box provided by each content provider, a broadcasting station of transmitting a broadcast signal, a cable broadcasting station of providing content through a cable, a media server of providing media through the Internet, etc.

The server 30 may provide content, or provide services of collecting and distributing a learning model to recognize the identifier of the content provider, recognizing a voice, etc. The server 30 may be embodied by one or more servers with regard to each service.

In the case of collecting or distributing the learning model, the server 30 may collect the main learning model and/or the self-learning model for recognizing the identifier of the content provider from a plurality of electronic apparatuses 10, verify the main learning model and/or the self-learning model by analyzing similarity, and distribute the verified main learning model and/or self-learning model to the electronic apparatuses related to each content provider.

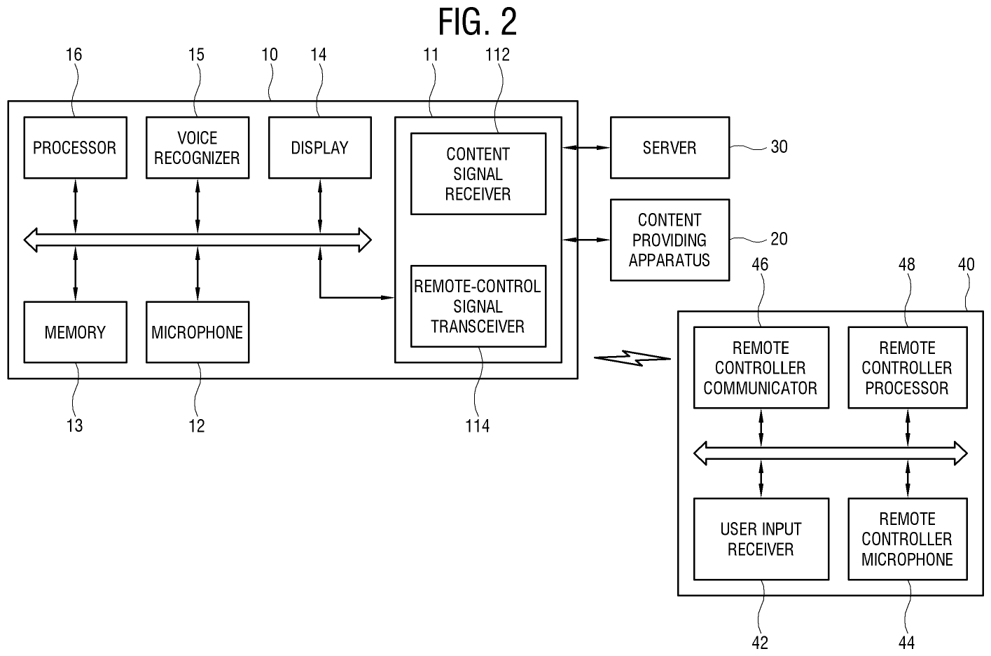

FIG. 2 is a block diagram of the electronic apparatus 10 of FIG. 1. The electronic apparatus 10 may include a signal input/output unit 11, a microphone 12, a memory 13, a display 14, a voice recognizer 15, and a processor 16. The signal input/output unit 11 may include a content signal receiver 112, and a remote-control signal transceiver 114.

The content signal receiver 112 receives a content signal from a skywave broadcasting station, a cable broadcasting station, a media broadcasting station, etc. The content signal receiver 112 may receive a content signal from a set-top box and the like dedicated content providing apparatus 20 or from a smartphone and the like personal mobile terminal. The content signal received in the content signal receiver 112 may be a wired signal or a wireless signal, and may be a digital signal or an analog signal. The content signal may be a skywave signal, a cable signal, a satellite signal or a network signal. The content signal receiver 112 may additionally include a universal serial bus (USB) port or the like to which a USB memory is connectable. The content signal receiver 112 may be embodied by the HDMI, the DP, the thunderbolt, or the like capable of receiving both video/audio signals. Of course, the content signal receiver 112 may include an input port and an output port to and from which video/audio signals are input and output. Further, the video and audio signals may be transmitted and received together or individually.

The content signal receiver 112 may receive an image signal of one channel among a plurality of channels under control of the processor 16. The image signal carries the image content and/or EPG UI provided by the content provider. The image content includes various broadcasting programs such as a soap opera, a movie, news, sports, music, video on demand (VOD), etc. without limitations.

The content signal receiver 112 may perform network communication with the content providing apparatus 20, the server 30, or other apparatuses. The content signal receiver 112 may transmit the self-learning model generated in the electronic apparatus 10 to the server 30. The content signal receiver 112 may receive the main learning model, and/or the self-learning model, etc. from the server 30. The content signal receiver 112 may include a radio frequency (RF) circuit to transmit/receive an RF signal for wireless communication, and may be configured to perform one or more types of communication among Wi-Fi, Bluetooth, Zigbee, ultra-wide band (UWB), wireless USB, and Near Field Communication (NFC). The content signal receiver 112 may perform wired communication through a wired local area network (LAN). Besides connectors including a connector or terminal for the wired connection, various other communication methods may be applicable. The remote control signal transceiver 114 receives a remote control signal, for example, an infrared (IR) signal, a Bluetooth signal, a Wi-Fi signal, etc. from the remote controller 3. Further, the remote control signal transceiver 114 may transmit an IR signal, a Bluetooth signal, a Wi-Fi signal, etc. including a command information for controlling an external apparatus such as the content providing apparatus 20.

The electronic apparatus 10 may include dedicated communication modules for performing dedicated communication with the content providing apparatus 20, the server 30, and the remote controller 40, respectively. For example, to perform the communication, the content providing apparatus 20 may use an HDMI module, the server 30 may use an Ethernet modem or a Wi-Fi module, and the remote controller 40 may use a Bluetooth module or an IR module.

The electronic apparatus 10 may include a common communication module or the like to perform communication with all of the content providing apparatus 20, the server 30, and the remote controller 40. For example, the content providing apparatus 20, the server 30, and the remote controller 40 may perform communication through the Wi-Fi module.

In addition to the content signal receiver 112, the electronic apparatus 10 may further include a content signal output unit to output a content signal to the outside. In this case, the content signal receiver 112 and the content signal output unit may be integrated into one module, or may be provided as separate modules.

The microphone 12 may receive a user's voice. A user's voice may be received through other routes than the microphone 12. For example, a user's voice may be received through the remote controller 40, the user's another terminal such as the smartphone, or the like which has a microphone, but there are no limits to this. A user's voice received in the remote controller 40, another terminal, etc. may include various voice commands as described above to control the electronic apparatus 10. The received user's voice may be recognized by the voice recognizer 15 as a control command for controlling the electronic apparatus 10.

The memory 13 refers to a computer-readable recording medium, and is configured to store unrestricted data. The memory 13 is accessed by the processor 16 to read, write, modify, update, etc. data. The data stored in the memory 13 may for example include the main learning model for recognizing the identifier of the content provider, the self-learning model collected and learned from the image data, etc.

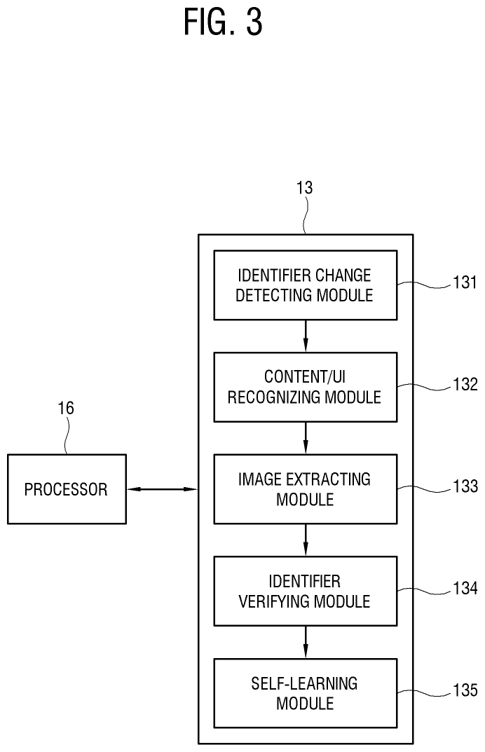

The memory 13 may, as shown in FIG. 3, include an identifier change detecting module 131 for detecting whether the identifier of the content provider included in the image data is changed; a content/UI recognizing module 132 for recognizing content, e.g. an EPG UI from the image data and detecting the EPG UI; an image extracting module 133 for recognizing the identifier included in the image data; an identifier verifying module 134 for identifying the recognized identifier; and a self-learning module 135 for learning the verified identifier and generating the self-learning model, which are executable by the processor 16.

The memory 13 may include a voice recognition module (or a voice recognition engine) for recognizing a received voice. Of course, the memory 13 may include an operating system, various applications executable on the operating system, image data, appended data, etc.

The memory 13 includes a nonvolatile memory in which the control program is installed, and a volatile memory to which at least a part of the installed control program is loaded.

The memory 13 may include a storage medium of at least one type among a flash memory type, a hard disk type, a multimedia card micro type, a card type (e.g. SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disc, or an optical disc.

The display 14 displays an image based on an image signal subjected to signal processing. The display 14 may display digital content stored in the memory 13 or received from the content providing apparatus 20 or the server 30 through the signal input/output unit 11.

There are no limits to the type of the display 14. For example, the first display 130 may be embodied in various display panels of liquid crystal, plasma, light-emitting diodes, organic light-emitting diodes, a surface-conduction electron-emitter, a carbon nano-tube, nano-crystal, etc.

The display 14 may further include an additional element according to its types. For example, the display 14 may include a liquid crystal display (LCD) panel, an LCD panel driver for driving the LCD panel, and a backlight unit for illuminating the LCD panel.

The voice recognizer 15 may execute the voice recognition module (or the voice recognition engine) stored in the memory 13, and recognize a user's voice received through the microphone 12, the remote controller 40, etc. The voice recognizer 15 recognizes whether a user's voice is a control command for controlling the electronic apparatus 10. The control command may for example include commands for turning on or off the electronic apparatus 10, channel switching, volume control, etc. Further, the control command may for example include a command for requesting display of a UI provided by the content providing apparatus 20 connected to the electronic apparatus 10.

An analog voice signal received in a remote controller microphone 42 may be converted into a digital signal and transmitted to the electronic apparatus 10 through, for example, Bluetooth or the like. Alternatively, an analog voice signal received in the microphone 12 internally provided in the electronic apparatus 10 may be converted into a digital signal and transmitted to the processor 16 of the electronic apparatus 10. Like this, the received voice signal is converted into a text through the voice recognizer 15 internally provided in the electronic apparatus 10.

The voice recognizer 15 may be excluded from the electronic apparatus 10. In this case, the received voice signal may be transmitted to the server (or the voice recognition server) 30.

The server (or the voice recognition server) 30 may be a speech-to-text (STT) server having only a function of converting data related to a voice signal into a proper text or a main server also serving as the STT server.

The STT server may return the processed data to the electronic apparatus 10, or may directly transmit the processed data to another server.

As described above, the processor 16 of the electronic apparatus 10 may perform a specific function based on a text received in the electronic apparatus 10 or a text autonomously converted by the voice recognizer 15 of the electronic apparatus 10. In this case, a converted text may also be transmitted to and processed in a separate server (or a server different from the STT server or a server serving as the STT server), and then information/data of the processed text may be returned to the electronic apparatus 10, so that the specific function can be implemented based on the information/data.

The processor 16 may control the parts of the electronic apparatus 10. The processor 16 may for example recognize the identifier of the content provider from the image content and/or EPG UI received in response to a user's request, and perform operation based on information of the content provider corresponding to the recognized identifier. In other words, the processor 16 may for example control the image content and/or EPG UI provided by the recognized content provider to be displayed on the internal or external display 14.

The processor 16 may analyze an image received from the content providing apparatus 20 or received by streaming through the network, and recognize an identifier of a specific content provider within the image.

The processor 16 may execute the identifier change detecting module 131 stored in the memory 13 so as to detect whether the identifier of the content provider included in the image data is changed or not. The processor 16 may execute the content-UI recognizing module 132 stored in the memory 13 so as to recognize the content and EPG UI in the image data and detect the EPG UI. The processor 16 may execute the image extracting module 133 stored in the memory 13 so as to extract an image present in an identifier region of the identifier mask. The processor 16 may execute the identifier verifying module 134 stored in the memory 13 so as to verify whether the extracted image is recognizable as the identifier of the content provider. The processor 16 may execute the self-learning module 135 stored in the memory 13 so as to learn the verified identifier and generate the self-learning model.

The processor 16 may recognize the identifier of the content provider within the received image based on the main learning model stored in the memory 13, and recognize the identifier of the content provider based on the self-learning model stored in the memory 13 when the recognition fails due to change in the identifier.

The processor 16 may include at least one common processor, for example, a central processing unit (CPU), an application processor (AP) or a microprocessor, which loads at least a part of a control program from a nonvolatile memory installed with the control program to a volatile memory, and executes the loaded control program.

The processor 16 may include a single-core processor, a dual-core processor, a triple-core processor, a quad-core processor, and the like multiple-core processor. The processor 16 may include a plurality of processors. The processor 16 may for example include a main processor and a sub processor that operates in a sleep mode (e.g. when only standby power is supplied). Further, the processor, the ROM and the RAM are connected to one another via an internal bus.

The processor 16 may be achieved as included in a main SoC mounted to a built-in PCB of the electronic apparatus 10. Alternatively, the main SoC may further include the image processor.

The control program may include a program(s) achieved in the form of at least one among a basic input/output system (BIOS), a device driver, an operating system, a firmware, a platform, and an application. The application may be previously installed or stored when the electronic apparatus 10 is manufactured, or may be installed for use in the future on the basis of data received corresponding to the application from the outside. The data of the application may for example be downloaded from an external server such as an application market to the electronic apparatus 10. Such an external server is an example of a computer program product, but not limited thereto.

The remote controller 40 may be embodied by an IR remote controller that transmits 2-bit control information based on only an IR signal, or a multi-brand remote controller (MBR) that transmits user input information input by for example a button, a voice, a touch, dragging, etc. through an IR signal, a Bluetooth signal, a Wi-Fi signal, etc., or a smartphone or the like mobile terminal installed with a remote control application (app). The remote controller 40 may include a user input receiver 42, a remote controller microphone 44, a remote controller communicator 46, and a remote controller processor 48.

The user input receiver 42 may receive a button input through various function-key buttons, a touch or dragging input through a touch sensor, a voice input through the remote controller microphone 44, a motion input through a motion sensor, etc.

The remote controller microphone 44 may receive a user's voice input. Thus, the received analog voice input is converted into a digital signal, and transmitted to a target to be controlled, for example, to the electronic apparatus 10 through the remote controller communicator 46, for example, a Bluetooth communication module, a Wi-Fi communication module, an infrared communication module, etc. When the remote controller 40 is embodied by a smartphone or the like mobile terminal having the voice recognition function, the received voice input may be transmitted to the electronic apparatus 10 in the form of a control signal recognized through the voice recognition. A user's voice input may include a command for turning on/off the electronic apparatus 10, a channel switching command, a volume control command, a command for requesting a home or guide image of the content provider.

The remote controller communicator 46 may transmit a control command received in the user input receiver 42, a digital voice signal converted from an analog voice signal, and the like data to the signal input/output unit 11 of the electronic apparatus 10.

The remote controller communicator 46 may be configured to perform one or more among IR, RF, Wi-Fi, Bluetooth, Zigbee, UWB, Wireless USB, and NFC communications to perform the wireless communication.

The remote controller processor 48 may control the parts of the remote controller 40. The remote controller processor 48 may transmit a control command corresponding to a button input, a touch input, a dragging input, or a motion input to the electronic apparatus 10 through the remote controller communicator 46.

The remote controller processor 48 may convert an analog voice signal received in the remote controller microphone 44 into a digital voice signal, and transmits the digital voice signal to the electronic apparatus 10 through the remote controller communicator 46. When the remote controller 40 has a voice recognition function, the remote controller processor may recognize an input voice signal and transmit a corresponding control command to the electronic apparatus 10 through the remote controller communicator 46.

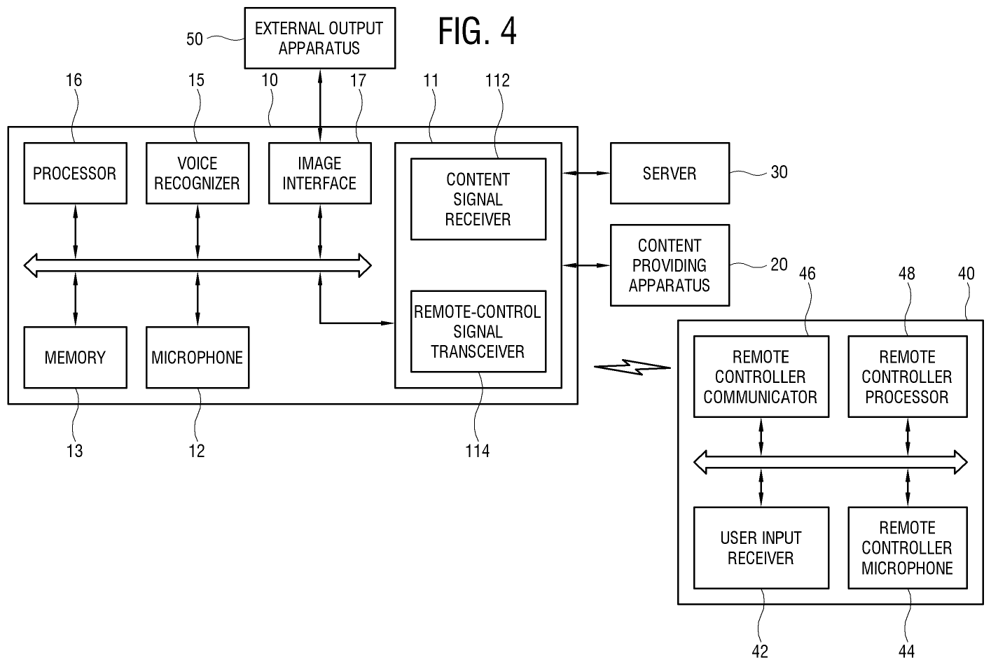

FIG. 4 is a block diagram of an electronic apparatus 10 according to a second embodiment of the disclosure. The electronic apparatus 10 according to the second embodiment may receive content and information from a connected server, and output the content and information to a separate external output apparatus 50. For example, the electronic apparatus 10 may output an image to a display apparatus, and output a sound to an audio apparatus.

Of course, the electronic apparatus 10 according to the second embodiment may include a display not for outputting the image content and/or EPG UI but for displaying a simple notification, a control menu, etc. of the electronic apparatus 10.

The electronic apparatus 10 according to the second embodiment may include the signal input/output unit 11, the microphone 12, the memory 13, the voice recognizer 15, the processor 16, and an image interface 17. Below, only different features will be described avoiding repetitive descriptions as compared with the features of FIG. 2.

The electronic apparatus 10 according to the second embodiment may transmit the image content and/or EPG UI to the external output apparatus 50 connected to the image interface 17, unlike the electronic apparatus 10 according to the first embodiment.

The signal input/output unit 11 may receive the image content and/or EPG UI from a specific content provider.

The processor 16 may control the parts of the electronic apparatus 10. The processor 16 may for example recognize the identifier of the content provider from the image content and/or EPG UI received in response to a user's request, and perform operation based on information of the content provider corresponding to the recognized identifier. In other words, the processor 16 may control the image content and/or EPG UI provided by the recognized content provider to be transmitted to the external output apparatus 50 through the image interface 17.

The image interface 17 may be embodied by the HDMI, the DP, the thunderbolt, or the like port capable of receiving both video/audio signals processed in the electronic apparatus 10. Of course, the image interface 17 may be embodied by ports capable of recognizing and outputting the video/audio signals, respectively.

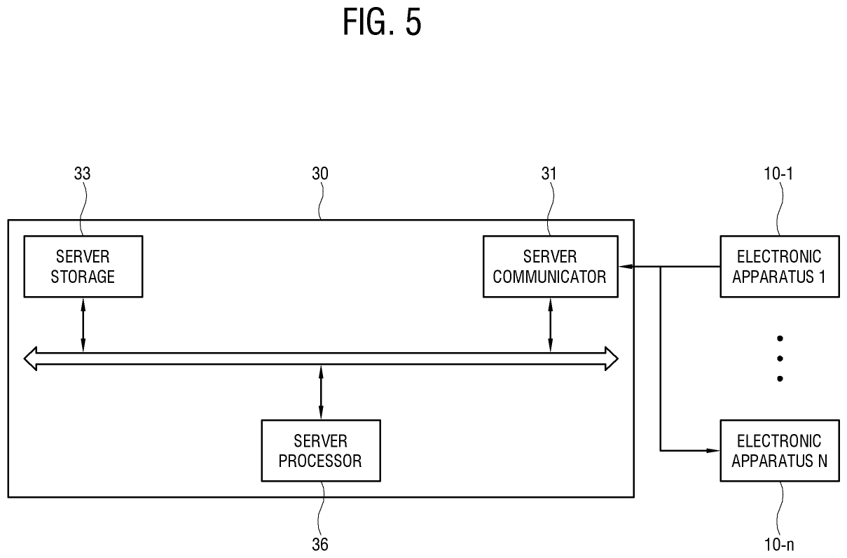

FIG. 5 is a block diagram of the server 30 according to an embodiment of the disclosure;

Referring to FIG. 5, the server 30 may include a server communicator 31, a server memory 33, and a server processor 36.

The server communicator 31 performs network communication with a plurality of electronic apparatuses 10-1˜10-n. The server communicator 31 may receive the self-learning model generated in the electronic apparatus 10. The server communicator 31 may receive the main learning model, and/or the self-learning model, etc. from the plurality of electronic apparatuses 10-1˜10-n.

The server communicator 31 may distribute the main learning model, and/or the self-learning model, etc., which are collected and processed under control of the server processor 36, to the electronic apparatuses 10-1˜10-n corresponding to the identifiers of the content providers.

The server communicator 31 may for example include an RF circuit to transmit/receive an RF signal for wireless communication with the plurality of electronic apparatuses 10-1˜10-n, and may be configured to perform one or more types of communication among Wi-Fi, Bluetooth, Zigbee, UWB, wireless USB, and NFC. The server communicator 31 may perform wired communication with the plurality of electronic apparatuses 10-1˜10-n and other apparatuses through a wired LAN. Besides connectors including a connector or terminal for the wired connection, various other communication methods may be applicable.

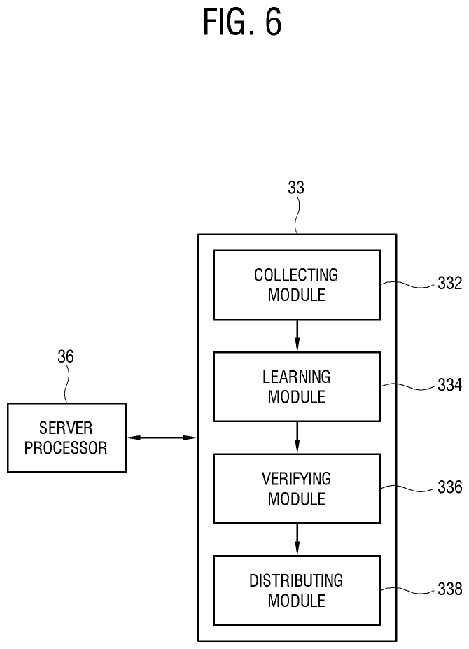

The server memory 33 may include various pieces of unrestricted data. For example, the server memory 33 may, as shown in FIG. 6, include a collecting module 332 for collecting the main learning model and/or the self-learning model from the plurality of electronic apparatuses 10-1˜10-n, a learning module 334 for learning similarity of the collected main learning and/or self-learning models, a verifying module 336 for verifying the most similar main learning and/or self-learning models by learning, and a distributing module 338 for distributing the verified main learning and/or self-learning models to the electronic apparatuses 10-1˜10-n related to each content provider.

The server processor 36 may execute the collecting module 332 stored in the server memory 33 so as to collect the main learning model and/or the self-learning model from the plurality of electronic apparatuses 10-1˜10-n, execute the learning module 334 stored in the server memory 33 so as to learn the similarity of the collected main learning and/or self-learning models, execute the verifying module 336 stored in the server memory 33 so as to verify the most similar main learning and/or self-learning models, and execute the distributing module 338 stored in the server memory 33 so as to distribute the verified main learning and/or self-learning models to the electronic apparatuses 10-1˜10-n related to each content provider.

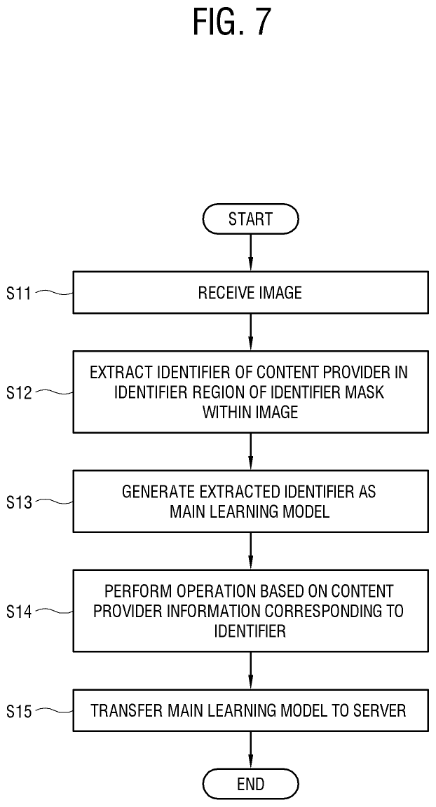

Below, a method of recognizing an identifier of a content provider within an image by the electronic apparatus according to the first embodiment of the disclosure will be described with reference to FIGS. 7 to 13.

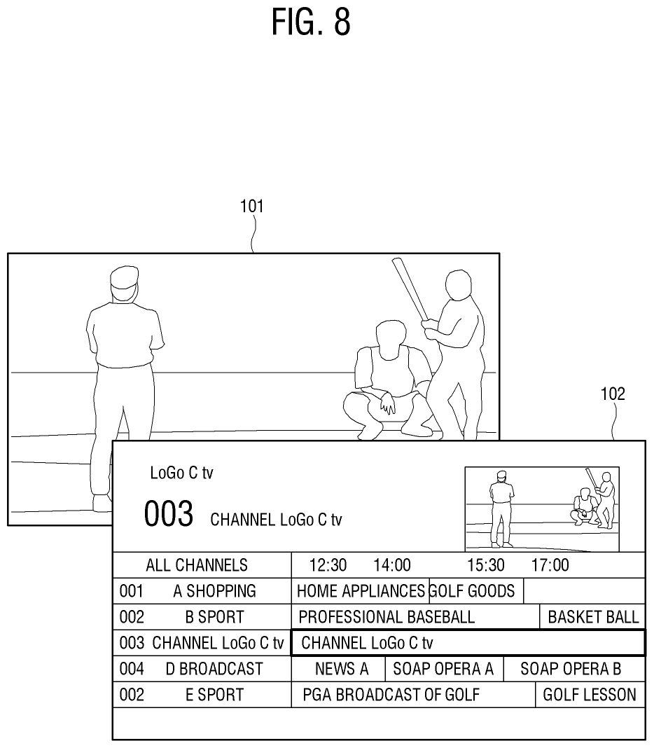

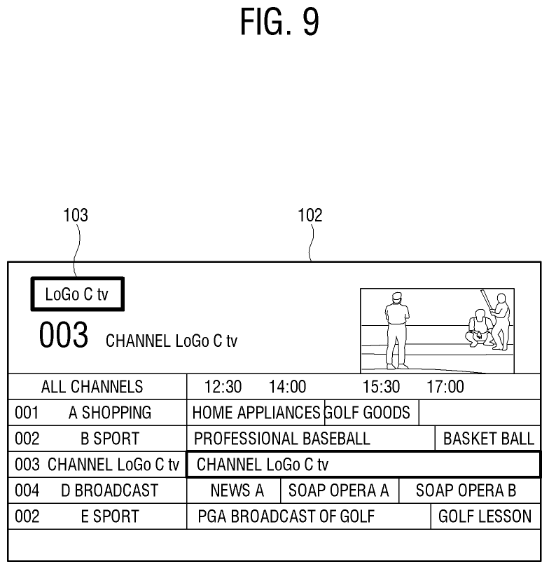

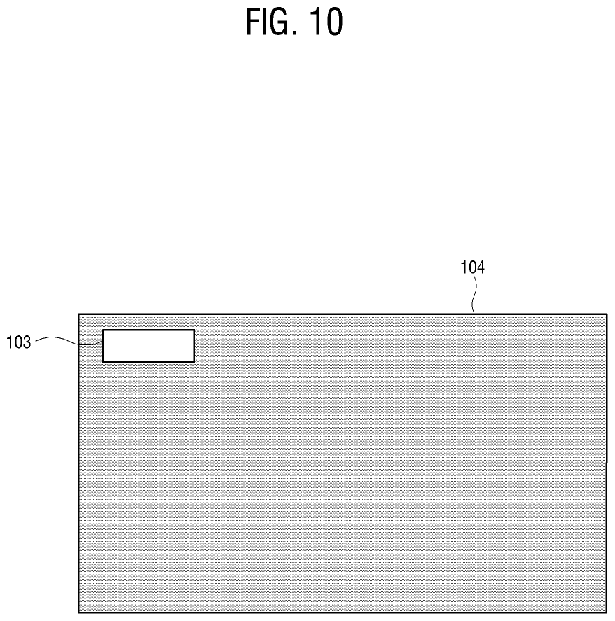

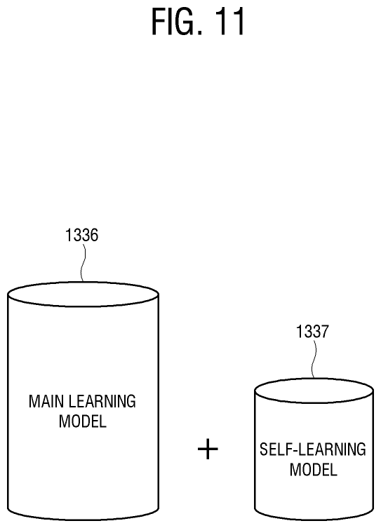

FIG. 7 is a flowchart showing a method of recognizing an identifier of a content provider from a received image by the electronic apparatus 10 according to the first embodiment of the disclosure; FIG. 8 illustrates image data provided by the content provider, received through the signal input/output unit 11 of the electronic apparatus 10; FIG. 9 illustrates an EPU UI recognized from the image data of FIG. 8; FIG. 10 illustrates an identifier mask 104 according to an embodiment of the disclosure; and FIG. 11 illustrates a main learning or self-learning model generated based on an identifier of a verified content provider.

At operation S11, the signal input/output unit 11 of the electronic apparatus 10 may receive image data provided by the content provider. As shown in FIG. 8, the image data includes image content 101 and the EPG UI 102. The EPG UI 102 may include the identifier, for example, the logo of the image content provider at a specific region. For example, the EPG UI 102 includes an identifier of “LoGo C tv” at a left upper portion. Of course, the image data may include only one of the image content 101 and the EPG UI 102.

At operation S12, the processor 16 may execute the image extracting module 133 to extract the identifier of the content provider (e.g. “LoGo C tv”) at a specific identifier region 103 in the EPG UI shown in FIG. 9. The processor 16 may apply the identifier mask 104 having a specific identifier region 103 as shown in FIG. 10 while extracting the identifier (e.g. “LoGo C tv”). Here, it is assumed that the position or shape of the identifier of the content provider in the received image data is known when the content providing apparatus 20 is first connected to the electronic apparatus 10, the processor 16 applies the identifier mask 104 having the identifier region 103 to the received image data, thereby extracting the identifier of the content provider present in the identifier region 103. Here, the identifier region 103 may be represented with an x-y coordinate region regarding the center of the image as the origin.

At operation S13, the processor 16 may generate the identifier of the content provider, which is extracted in response to a command of an engineer or a user or autonomously, as a main learning model 1336 or a self-learning model 1337 as shown in FIG. 11. Here, the main learning model or the self-learning model may be represented with a binary value of one pixel or M by N block pixels as an image included in the identifier region 103 of the image data.

At operation S14, the processor 16 may perform various operations based on content provider information corresponding to the identifier of the content provider. In other words, the processor 16 may display a content image based on the content provider information on the display 14 or transmit the image through the image interface 17 so as to be displayed on the external output apparatus 50, for example, a monitor, a TV, etc.

At operation S15, the processor 16 may transmit the generated main learning model or self-learning model to the server 30.

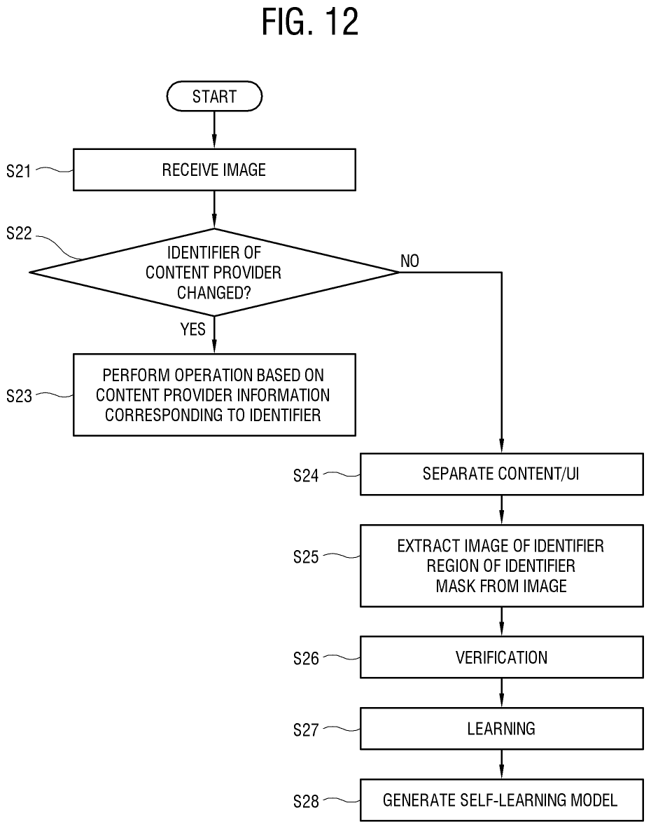

Below, a method of automatically recognizing an identifier of a content provider from an image according to the second embodiment of the disclosure will be described with reference to FIGS. 12 to 21.

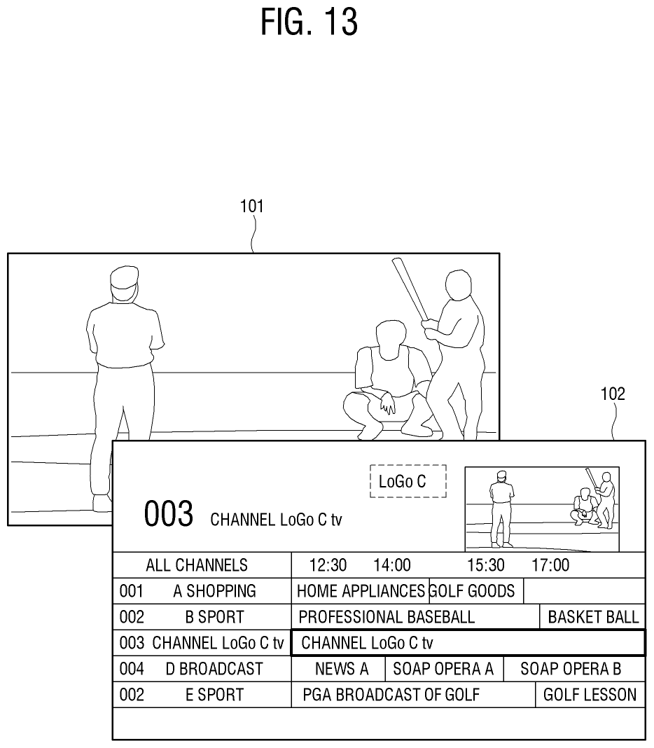

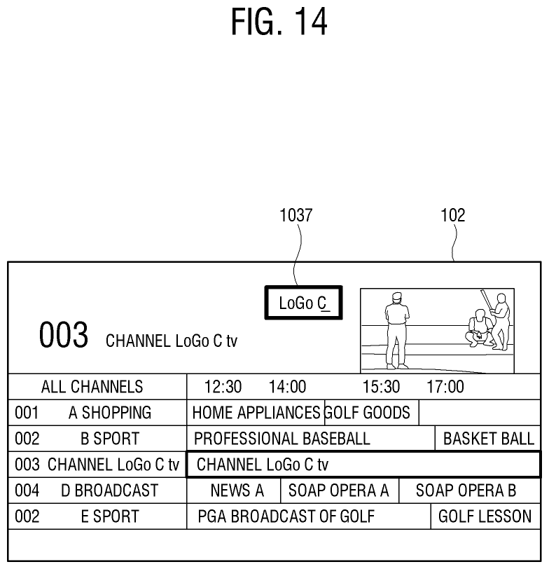

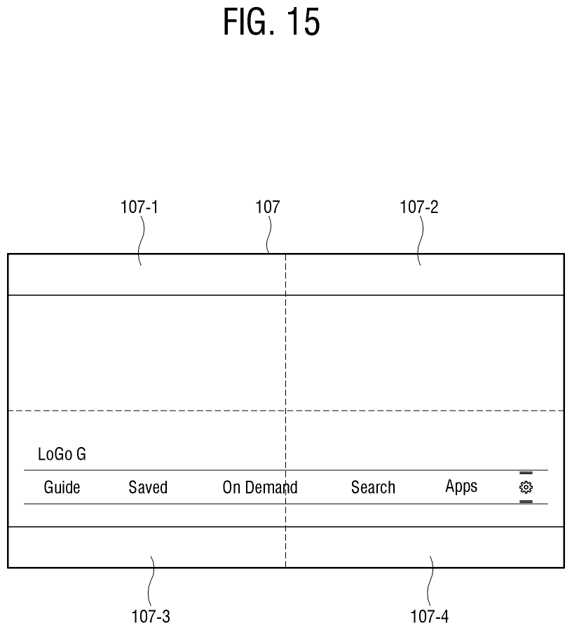

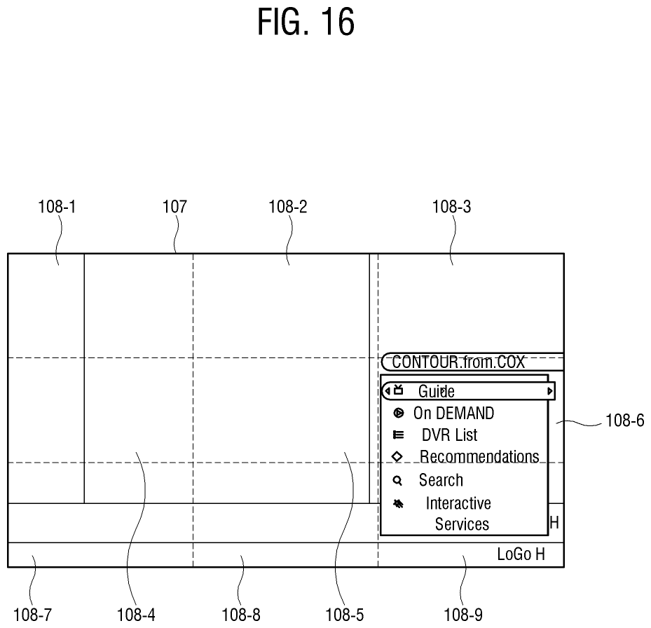

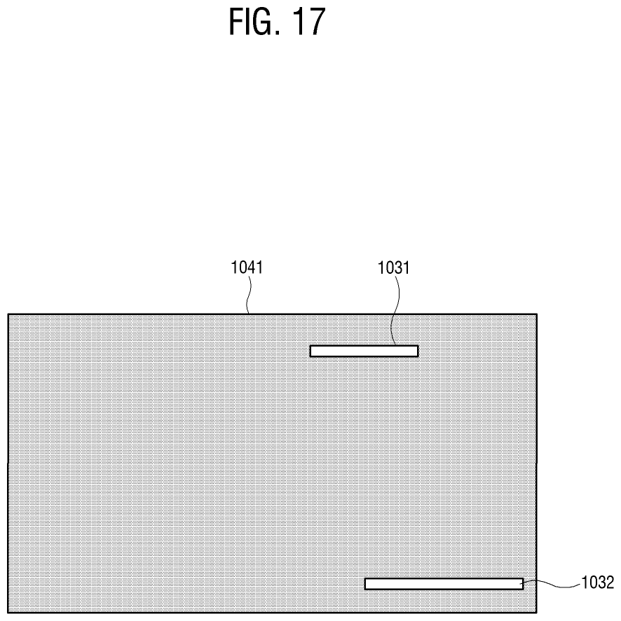

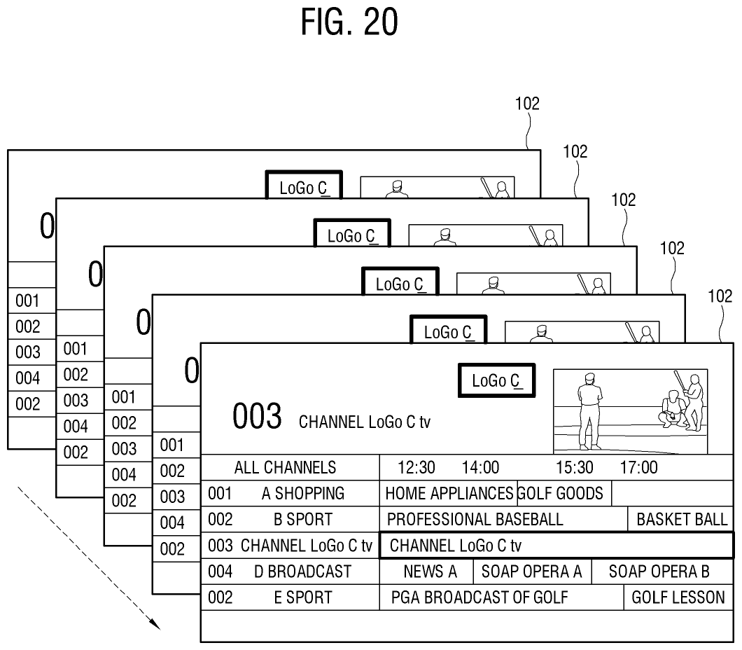

FIG. 12 is a flowchart showing a method of automatically recognizing an identifier of a content provider from a received image by the electronic apparatus 10 according to the second embodiment of the disclosure; FIG. 13 illustrates change in the identifier of the content provider from the image data of FIG. 8; FIG. 14 illustrates the EPG UI 102 recognized from the image data of FIG. 13; FIGS. 15 and 16 illustrate examples of dividing image data in which content and a UI are not clearly distinguished; FIGS. 17 to 19 illustrate second to fourth identifier masks 1041-1043; and FIG. 20 illustrates image data for verification of images extracted from an identifier region.

At operation S21, when a user uses a smart MBR remote controller to transmit a home or guide key to the image providing apparatus 20, the electronic apparatus 10 may receive the image data provided by the content provider through the signal input/output unit 11. The image data may, as shown in FIG. 13, include the content 101 and the menu EPG UI 102. In this case, the processor 16 cannot recognize the identifier of the content provider, i.e. “LoGo C” at the left upper portion in the image data shown in FIG. 13, unlike that of FIG. 8. This is because “LoGo C” is changed in position from the left upper portion to the middle upper portion and in logo into “LoGo C” in the image data provided by the content providing apparatus 20. In this case, although the processor 16 fails in the recognition due to the change in the identifier of the content provider, it is possible to continuously receive the image content by recognizing the content provider as the existing content providing apparatus 20 because the content providing apparatus 20 has already been connected. However, when the electronic apparatus 10 and the content providing apparatus 20 are disconnected from each other and then connected again due to moving, repairing, or the like causes, the processor 16 cannot recognize the content providing apparatus 20 from the image data in which the identifier of the content provider is changed.

At operation S22, the identifier change detecting module 131 executed by the processor 16 may detect whether the identifier of the content provider is changed in the image whenever receiving a home key or a guide key from the remote controller 40. For example, the identifier change detecting module 131 may detect when the identifier of the content provider is changed in the image data shown in FIG. 13, as compared with the identifier (e.g. “LoGo C”) and its position (e.g. the left upper portion) shown in the EPG UI 102 of FIG. 8. The processor 16 performs operation S23 when the identifier of the content provider is not changed, but performs operation S24 when the identifier is changed.

At operation S23, the processor 16 may perform operation based on the content provider information corresponding to the unchanged identifier.

At operation S24, the content-UI recognizing module 132 executed by the processor 16 can, as shown in FIG. 14, separate only the EPG UI 102 from the image data of FIG. 13. Because the identifier is generally included in the UI, the UI recognizing module 132 may first identify whether the image data is content or a UI, and then find the identifier of the content provider only in the UI, to thereby rapidly and accurately find the identifier region from the image data. The content-UI recognizing module 132 may use a learning algorithm, for example, a support vector machine (SVM), or the like to distinguish between the content and the UI within the image data.

In a case of the image data in which the content and the UI are hardly distinguishable, the UI may be misrecognized as the content. To prevent such misrecognition, the content-UI recognizing module 132 may divide a screen into N sectional regions, and then apply a sectional UI-searching algorithm that identifies whether a screen similar to a UI is present in each section region.

The content-UI recognizing module 132 may, as shown in FIG. 15, divide a screen 107 into four sectional regions 107-1˜107-4 and search for the screen similar to the UI. In this case, two sectional regions 107-3 and 107-4 have similar screens to the UI, and “LoGo G” is positioned in one sectional region 107-3 as the identifier of the content provider.

The content-UI recognizing module 132 may, as shown in FIG. 16, divide a screen 108 into nine sectional regions 108-1˜108-9 and search for the screen similar to the UI. In this case, four sectional regions 108-1, 108-2, 108-4 and 108-5 include only content, two sectional regions 108-6 and 108-9 have similar screens to the UI, and “LoGo H” is positioned in one sectional region 108-9 as the identifier of the content provider.

At operation S25, the image extracting module 133 executed by the processor 16 may use a plurality of, for example, second to fourth identifier masks 1041-1043 shown in FIGS. 17 to 19 to extract images corresponding to the identifier regions 1031-1036 from the recognized EPG UI 102 of FIG. 14.

The second identifier mask 1041 shown in FIG. 17 includes the identifier regions 1031 and 1032 at right upper and lower portions where the presence of the identifier of the content provider is expected.

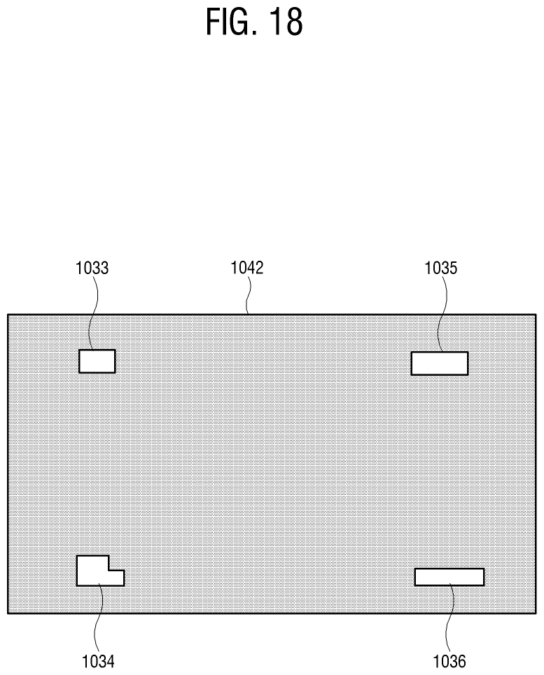

The third identifier mask 1042 shown in FIG. 18 includes the identifier regions 1033-1036 at left upper and lower portions and right upper and lower portions where the presence of the identifier of the content provider is expected.

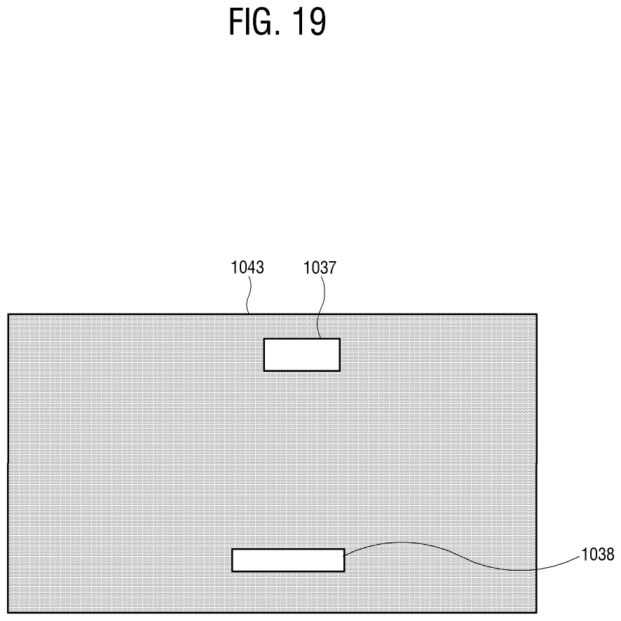

The fourth identifier mask 1043 shown in FIG. 19 includes the identifier regions 1037 and 1038 at middle upper and lower portions where the presence of the identifier of the content provider is expected.

Here, the second to fourth identifier masks 1041-1043 are merely an example for the description, and more identifier masks may be applied to improve the accuracy of the identifier recognition. Further, the identifier regions 1031-1036 included in the second to fourth identifier masks 1041-1043 may be set by analyzing the existing positions of the identifiers (i.e. the logos) of 259 content providers from 52 countries and referring to the positions where the identifiers are respectively expected according to the countries.

At operation S26, the identifier verifying module 134 executed by the processor 16 may verify whether the images extracted from the plurality of identifier regions are repetitively extracted from the corresponding identifier regions of the image data received whenever the guide or home key of the remote controller 40 is received.

For example, the identifier verifying module 134 may verify whether “LoGo C” extracted in the identifier region 1037 at the middle upper portion of the fourth identifier mask 1043 is present five or more times. Such a verified “LoGo C” may be subjected to the next learning. The identifier verifying module 134 may perform the verification with regard to all the images extracted from all the identifier regions 1031-1036 and perform the learning with regard to the extracted images satisfying predetermined conditions.

Here, the extracted and verified image is not necessarily changed from the main learning model for recognizing the identifier of the content provider, but may be another identifier of the content provider. Further, there may be a plurality of extracted and verified images.

At operation S27, the self-learning module 135 executed by the processor 16 may perform self-learning with respect to the images verified in the operation S26, based on, for example, the Caffe Tiny CNN library. The self-learning module 135 may use a transfer learning technique that reuses the learning model to learn the currently extracted and verified images in addition to the existing main learning model and/or self-learning model. While reusing the existing model to perform the learning, the self-learning module 135 uses an operation of M×N pixel blocks to M×N pixel blocks instead of an operation of one pixel to one pixel, thereby improving a leaning speed. Like this, the self-learning module 135 uses the M×N pixel blocks merged into one pixel, thereby improving the leaning speed four times faster in case of 2×2 and nine times faster in case of 3×3 than before. Of course, the self-learning module 135 may use the operation of one pixel to one pixel.

At operation S28, the processor 16 may first identify whether misrecognition occurs in the self-learning model generated with the extracted and verified images with respect to the existing learning model. When there is no misrecognition, the processor 16 then identifies whether the misrecognition occurs in the self-learning model by capturing the current image N times. the processor 16 employs a newly generated self-learning model only when there is no misrecognition in both identifications, but employs the existing learning model when there is misrecognition in either of the identifications.

According to an alternative embodiment, the processor 16 may intactly store and use the extracted image to recognize the identifier of the content provider from the image instead of applying the self-learning to the verified extracted image.

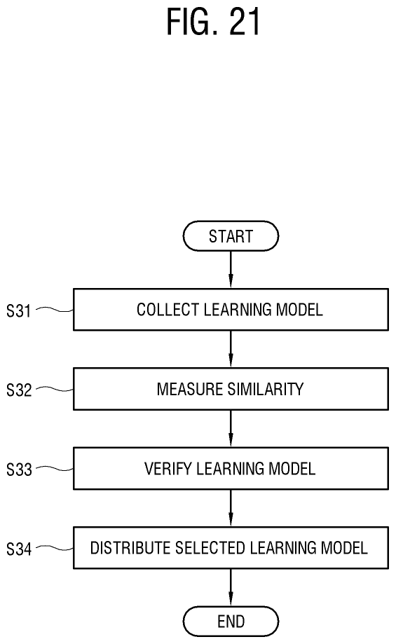

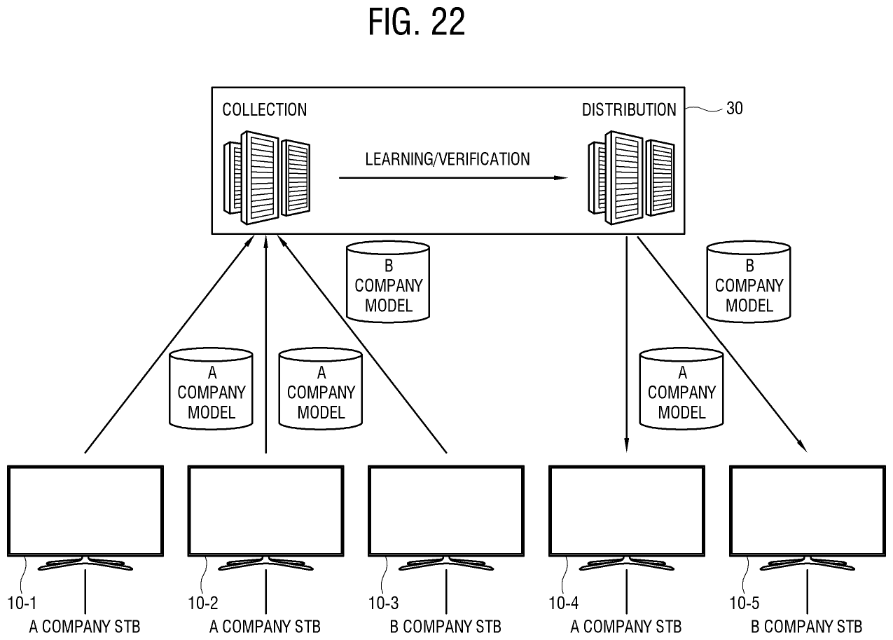

FIG. 21 is a flowchart showing operations of the server 30 according to an embodiment of the disclosure, and FIG. 22 is a schematic view of collection and distribution in the self-learning module according to an embodiment of the disclosure.

At operation S31, the collecting module 332 executed by the server processor 36 may collect the self-learning models, newly generated by three electronic apparatuses 10-1˜10-3, i.e. two A company models and one B company model. The server 30 may collect the main learning models and/or the self-learning models from more electronic apparatuses and more content providers without being limited to three electronic apparatuses 10-1˜10-3 and the A and B companies.

At operation S32, the learning module 334 executed by the server processor 36 may compare similarities between a plurality of self-learning models collected to find a solution to be distributed to other electronic apparatuses, and select a model to be finally used among the learning models having the maximum similarity. The collected learning models are given in the form of a binary file, and simple whole comparison is not valid. Therefore, the electronic apparatus 10 may send the server 30 the binary file attached with the learning data about the image added to the existing learning model. Like this, only the additionally attached data of the learning models is used in the comparison to identify the similarity, and it is thus easy to identify which models have the maximum similarity.

At operation S33, the verifying module 334 executed by the server processor 36 may verify whether the selected learning model having the maximum similarity does not affect the electronic apparatus related to the corresponding content provider.

At operation S34, the distributing module 338 executed by the server processor 36 may group the verified learning models according to countries and content providers, and distribute the grouped models together with downloadable apps to other electronic apparatuses 10-4 and 10-5.

According to an embodiment of the disclosure, the identifier change detecting module 131, the content-UI recognizing module 132 for recognizing the content and for example the EPG UI and extracting the EPG UI from the image data, the image extracting module 133 for recognizing the identifier included in the image data, the identifier verifying module 134 for identifying the identifier, and the self-learning module 135 for learning the identifier and generating the self-learning model may be embodied by a computer program product stored in the memory 13 as the computer-readable recording medium or a computer program product transmitted and received through network communication. Further, the foregoing modules may be independently or integrally embodied by a computer program.

According to an embodiment of the disclosure, the computer program may recognize an identifier of a content provider present in an identifier region of an image based on an identifier mask having an identifier region, in which the presence of the identifier is expected, within an image, verify whether the identifier recognized in the identifier region is repetitively recognized a predetermined number of times in a plurality of images, and generate the verified identifier as a self-learning model.

With the electronic apparatus according to the disclosure, an engineer does not need to take a direct visit to collect image data when an image providing apparatus is installed or replaced, and a learning model of a recognition engine capable of recognizing the image providing apparatus is generated.

The electronic apparatus according to the disclosure can recognize the image providing apparatus based on an additional learning model of a recognition engine even though an identifier (e.g. a logo, a UI) of a content provider is changed within an image.

Although a few embodiments of the disclosure have been illustrated and described, the disclosure is not limited to these embodiments, and various modifications can be made by a person having an ordinary knowledge in the art without departing from the scope of the disclosure and should be construed within the technical concept or prospect of the disclosure.

1. An electronic apparatus comprising:
a signal interface; and
a processor configured to:
process an image to be displayed based on a signal received through the signal interface,
identify an identifier of a content provider, present in an identifier region of the image, based on an identifier mask including the identifier region where presence of the identifier is expected within the image, and
perform an operation based on information of the content provider corresponding to the identified identifier.

2. The electronic apparatus according to claim 1, wherein the identifier region is a first identifier region, and
the processor is configured to generate a self-learning model by identifying the identifier of the content provider in a second identifier region of the image, based on a plurality of second identifier masks comprising one or more second identifier regions where presence of the identifier of the content provider is expected within the received image.

3. The electronic apparatus according to claim 2, wherein the processor is configured to detect whether the identifier of the content provider is changed within the image.

4. The electronic apparatus according to claim 1, wherein the processor is configured to identify and detect a user interface (UI) within the image.

5. The electronic apparatus according to claim 4, wherein the processor is configured to divide the image into a plurality of regions, and identify and detect the UI from the plurality of divided regions.

6. The electronic apparatus according to claim 5, wherein the processor is configured to identify the identifier of the content provider in the detected UI.

7. The electronic apparatus according to claim 1, wherein the identifier region is a first identifier region, and
the processor is configured to set the first identifier region or the second identifier region by referring to identifier positions of a plurality of content providers including the content provider.

8. The electronic apparatus according to claim 2, wherein the processor is configured to verify whether the identified identifier is repetitively identified a predetermined number of times in one identifier region.

9. The electronic apparatus according to claim 2, wherein the self-learning model comprises an image positioned in the first identifier region or the second identifier region.

10. The electronic apparatus according to claim 8, wherein the processor is configured to separate the verified identifier and apply a self-learning process to only the separated verified identifier.

11. The electronic apparatus according to claim 10, wherein the processor is configured to first compare main learning models for the identifier of the content provider within the received image, and second compare the main self-learning models based on no identification of the identifier.

12. The electronic apparatus according to claim 10, wherein the self-learning process comprises transfer learning that reuses a main learning model to learn the self-learning model.

13. The electronic apparatus according to claim 12, wherein the transfer learning uses pixel operation in units of M×N to M×N blocks.

14. The electronic apparatus according to claim 10, wherein the processor is configured to identify whether misidentification occurs in the self-learning model with respect to a main learning model, and identifies whether misidentification occurs in the self-learning model by capturing a current image N times, based on no misidentification in the self-learning model with respect to the main learning model.

15. The electronic apparatus according to claim 14, wherein the processor is configured to use the self-learning model based on no misidentification in the captured images, and use the main learning model based on the misidentification in the captured images.

16. The electronic apparatus according to claim 2, wherein the processor is configured to provide the generated self-learning model to an external server through the signal interface.

17. The electronic apparatus according to claim 2, wherein the processor is configured to receive a main learning model or the self-learning model from a server through the signal interface.

18. A method of controlling an electronic apparatus, comprising:
receiving an image;
identifying an identifier of a content provider, present in an identifier region of the image, based on an identifier mask including the identifier region where presence of the identifier is expected within the image; and
perform an operation based on information of the content provider corresponding to the identified identifier.

19. A server comprising:
a server communicator; and
a processor configured to:
collect a plurality of learning models generated as identifiers of content providers from a plurality of electronic apparatuses through the server communicator,
determine similarity of the collected plurality of learning models, and
select a learning model having a maximum similarity among the plurality of leaning models and distribute the selected learning model to electronic apparatuses among the plurality of electronic apparatuses related to the identifier of the content provider.

20. A non-transitory computer-readable recording medium having stored therein a computer program executable by a computer to cause the computer to execute an operation, the operation comprising:
identify an identifier of a content provider, present in an identifier region of the image, based on an identifier mask including the identifier region where presence of the identifier is expected within the image,
verify whether the identified identifier is identified a predetermined number of times in identifier regions of a plurality of images, and
generate the verified identifier as a self-learning model.
